(19) United States
(12) Patent Application Publication
(10) Pub. No.: US 2024/0198626 A1
(43) Pub. Date: Jun. 20, 2024

(54) Wear resistant decorative surface coverings, and process for manufacturing thereof

(71) Applicant: TARKETT GDL S.A., Lentzweiler (LU)

(72) Inventors: Nicolas BOQUILLON, Wiltz (LU); Adamik MAREK, Wiltz (LU); Pejak DRAGAN, Wiltz (LU)

(21) Appl. No.: 18/555,934

(22) PCT Filed: Apr. 15, 2022
(86) PCT No.: PCT/EP2022/060170

§ 371 Date: Oct. 18, 2023

(30) Foreign Application Priority Data
Apr. 19, 2021 (LU) LU 102788

(51) Int. Cl. B32B 5/16; B32B 5/02; B32B 5/26; B32B 37/06; B32B 37/10; B32B 37/24

(52) U.S. Cl. CPC B32B 5/16; B32B 5/022; B32B 5/024; B32B 5/26; B32B 37/06; B32B 37/1027; B32B 37/24; B32B 2255/04; B32B 2255/26; B32B 2262/101; B32B 2264/0242; B32B 2305/30; B32B 2307/404; B32B 2307/554; B32B 2307/584; B32B 2471/00

(57) ABSTRACT

A decorative surface covering (1) defining a thickness direction (N) and comprising an assembly (5) having along the thickness direction:— a core layer (5A) comprising a first thermoplastic composition (12), the first thermoplastic composition including one or several thermoplastic polymer(s), P1 phr of one or several filler(s), and P2 phr of one or several plasticizer(s),— at least one reinforcement layer (5B),— a wear layer (5D) comprising at least a second thermoplastic composition (14), and including one or several thermoplastic polymer(s), P1′ phr of one or several filler(s), and P2′ phr of one or several plasticizer(s). P1 and P2 are respectively greater than P1′ and P2′.

The present invention deals with decorative surface coverings, such as rolls or tiles, intended to be laid on a floor.

The invention also deals with a process for manufacturing such decorative surface coverings.

In order to obtain decorative surface coverings, it is well known to produce laminated slabs. A core layer is first produced, by calendaring or by using a double belt press. Then, other layers, such as a decorative layer and a wear layer, are then laminated on the core layer to produce the slab, usually cut to obtain the tiles.

A double belt press has at least a first belt on which granules of at least one thermoplastic material are scattered. The press allows pressing and heating the granules between the first belt and a second belt of the press in order to transform the granules into a core layer of the slab.

In order to reinforce the core layer of the slab, a reinforcement layer is sometimes added in the core layer. This can be performed for instance by applying a sheet of glass fibers on a first layer of granules, scattering a second layer of granules on the sheet, and then hot pressing this set in the double belt press to form the core layer, said core layer having no decorative layer.

As a consequence, in order to obtain a decorative surface coverings, a printed film needs to be laminated on the core layer. The printed film has a decorative pattern in order to provide a decorative aspect to the slab. In order to protect the printed film and to provide mechanical and abrasion resistance to the upper surface of the decorative surface coverings, a wear layer may be added on top of this printed film. Moreover, in order to increase the surface properties of said decorative surface coverings, it is well known to add a polyurethane layer on top of the wear layer.

However, these known surface decorative coverings are currently facing delamination issues between the core layer and the printed film when submitted to intense usage conditions, such as heavy load or high traffic.

Consequently, there is a need for a process for manufacturing decorative surface coverings, both resistant to delamination and remaining aesthetical.

To this end, the invention proposes a decorative surface covering defining a thickness direction and comprising an assembly having along the thickness direction:
a core layer comprising a first thermoplastic composition, the first thermoplastic composition including one or several thermoplastic polymer(s), P1 phr of one or several filler(s), and P2 phr of one or several plasticizer(s),
at least one reinforcement layer, and
a wear layer comprising at least a second thermoplastic composition, the second thermoplastic composition including one or several thermoplastic polymer(s), P1′ phr of one or several filler(s), and P2′ phr of one or several plasticizer(s), wherein P1 and P2 are respectively greater than P1′ and P2′.

In particular embodiments, the decorative surface covering comprises one or several of the following features, taken in isolation or any technically feasible combination:
said at least one reinforcement layer contains at least 50 wt % of glass fibers;
devoid of any printed film located on or above the assembly;
a coating layer located on the wear layer, the coating layer including a radiation-curable coating agent;
the radiation-curable coating agent comprises an oligomer and/or polymer selected from the group consisting of (meth)acrylic copolymers, polyether (meth)acrylates, polyester (meth)acrylates, epoxy (meth)acrylates, urethane (meth)acrylates, amino(meth)acrylates, melamine (meth)acrylates, silicone (meth)acrylates and phosphazene (meth)acrylates or a mixture thereof;
a second reinforcement layer adjacent to the first reinforcement layer, or sandwiched between two sub-layers of the core layer;
said one or several thermoplastic polymer(s) of the first composition and of the second composition are polyvinylchloride;
said one or several plasticizer(s) in the first thermoplastic composition and in the second thermoplastic compositions are phthalate-free;
said one or several plasticizer(s) in the first thermoplastic composition and in the second thermoplastic compositions are selected from the group consisting of the lower alkyl esters of fatty acids, the lower alkyl esters of aromatic diacids, benzoates, citrates, phosphates, sulfonates, the alkyl esters of cyclohexane dicarboxylic acids, the dialkyl esters of aliphatic dicarboxylic acids and the alkyl esters of aromatic di-, tri-, or tetra-carboxylic acids, with the exception of orthophthalic acid; and
the wear layer further comprises a third thermoplastic composition, the second thermoplastic composition and the third thermoplastic composition having distinct colors and forming shapes on an upper surface of the assembly.

The invention also relates to a process for manufacturing a decorative surface covering as described above, the process comprising the following steps:
scattering granules of the first thermoplastic composition on a conveying member in order to obtain a first layer of granules,
applying said at least one reinforcement layer on the first layer of granules,
scattering granules of at least the second thermoplastic composition above said at least one reinforcement layer in order to obtain a second layer of granules,
pressing and heating the first layer of granules, said at least one reinforcement layer and the second layer of granules until melting or at least softening the first layer of granules and the second layer of granules in order to obtain the assembly after cooling, and
   using the assembly in order to produce the decorative surface covering.

In particular embodiments, the step of pressing includes pressing the first layer of granules, the at least one reinforcement layer and the second layer of granules in a double-belt press.

The invention and its advantages will be better understood upon reading the following description, given solely by way of example and with reference to the appended drawings, in which:

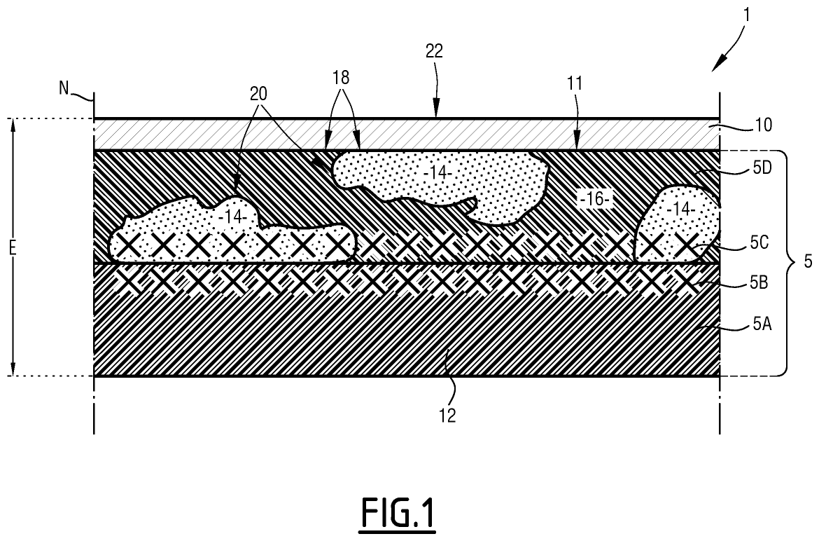

FIG. 1 is a schematic partial cross-sectional view of a surface covering according to the invention,

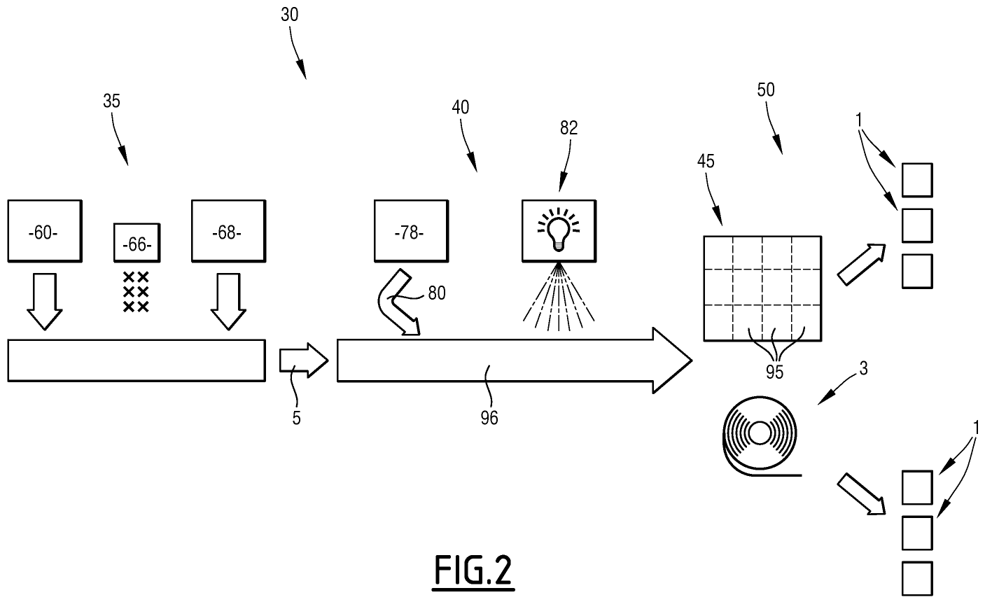

FIG. 2 is a schematic view of an installation implementing a process according to the invention,

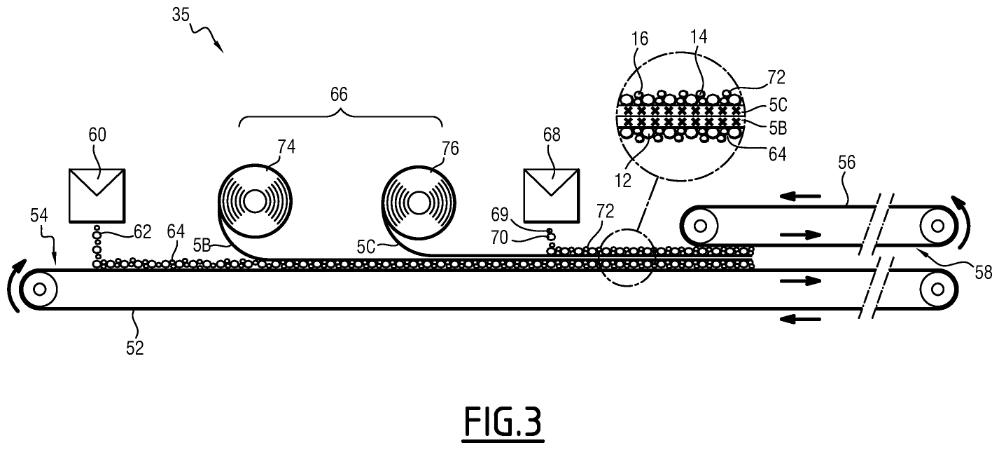

FIG. 3 is schematic view of a pressing system represented in FIG. 2, and

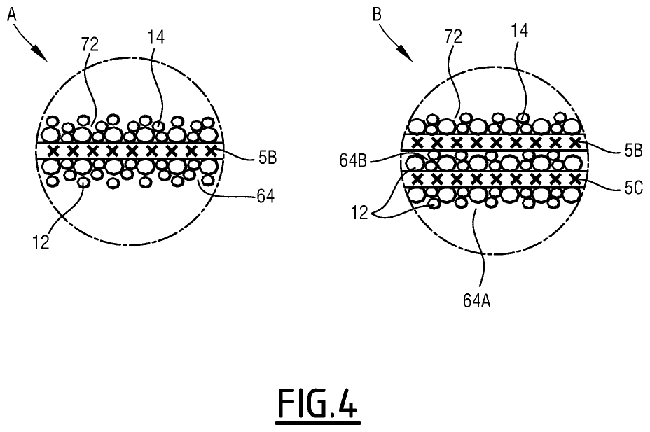

FIG. 4 is schematic view representing two variants of the pressing system represented in FIGS. 2 and 3.

### Floor Covering Element(s)

With reference to FIG. 1, a decorative surface covering 1 according to the invention is described. The other decorative surface coverings are analogous to this one.

The decorative surface covering 1 is for example a tile or a roll.

As a variant (schematically shown in FIG. 2), the decorative surface covering is a roll 3.

The surface to be decorated is for example a floor or a wall (not represented).

By “decorative”, it is meant that the surface covering 1 is intended to decorate the surface by modifying its external appearance.

The decorative surface covering 1 has a thickness E along a thickness direction N defined by the decorative surface covering itself. The decorative surface covering 1, in view along the thickness direction N, may have any shape allowing paving the floor: rectangular, square, triangular, hexagonal . . . etc.

The decorative surface covering 1 is intended to be applied on the surface adjacent to other decorative surface coverings (not represented) having the same shape or composition, or different ones. Advantageously the decorative surface covering 1 includes locking tabs (known in themselves and not represented) enabling to connect it to adjacent elements.

Successively in the thickness direction N, the decorative surface covering 1 comprises an assembly 5, and optionally a coating layer 10 located on an upper surface 11 of the assembly 5. This coating layer 10 is preferably a radiation-curable coating. The decorative surface covering 1 is advantageously devoid of any printed layer that would adhere on top of the assembly 5, either directly (on the assembly), or indirectly (with intermediate layers in between). In particular, no printed layer is laminated on or above the assembly 5.

Successively along the thickness direction N, the assembly 5 comprises a wear layer 5A, a first reinforcement layer 5B, optionally a second reinforcement layer 5C, and a wear layer 5D.

As a variant A illustrated in the left side of FIG. 4, the core layer 5 contains only one reinforcement layer 5B.

As others variants (not shown), there may be more than the two reinforcement layers 5B, 5C.

In the example shown in FIG. 1, the first and second reinforcement layers 5B, 5C are adjacent to each other (superimposed). The first and second reinforcement layers 5B, 5C are sandwiched between, and at least partly impregnated by the core layer 5A and the wear layer 5D.

Each of the reinforcement layers 5B, 5C for example contains at least 50 wt % of glass fibers. Advantageously, they are made of glass fibers. For example, they are fleeces of glass fibers, that is to say non-woven.

As a variant, the reinforcement layers 5B, 5C can be woven glass fibers, glass grids, crenettes or lenos.

In the example, the reinforcement layers 5B, 5C have the same composition, structure and thickness.

Each of the reinforcement layers 5B, 5C for example has a thickness comprised between 200 and 1000 μm.

As variants (not shown), the reinforcement layers 5B, 5C may differ from each other in terms of composition, structure or thickness.

Such reinforcement layers are for example commercially available from Johns Manville under the reference SH35/3, and from Saint Gobain Adfors under the reference U35.

The reinforcement layers 5B, 5C are advantageously in contact with each other. This means that no thermoplastic material is to be found in between them along the thickness direction N, except material resulting from an impregnation of the adjacent reinforcement layers during manufacturing.

According to other variants, the two reinforcement layers 5B and 5C may be spaced apart from each other in the thickness direction N. In that case, thermoplastic material is to be found between the two reinforcement layers 5B and 5C.

In a particular variant B shown in the right side of FIG. 4, the second reinforcement layer 5B is sandwiched within two sub-layers 64A, 64B of the core layer 5A. This will be further explained below.

The core layer 5A comprises at least a first thermoplastic composition 12. In the example, the core layer 5A is made of the first thermoplastic composition 12.

The wear layer 5D is advantageously an homogenous product as defined by the 2019 norm ISO/FDIS 10581.

In the example shown in FIG. 1, the wear layer 5D comprises a second thermoplastic composition 14 and a third thermoplastic composition 16 having distinct colors for a user (not represented) and forming shapes 18 on the upper surface 11 of the assembly 5.

The second thermoplastic composition 14 advantageously includes at least one first pigment.

Advantageously, the third thermoplastic composition 16 includes at least one second pigment different from the first pigment.

In a particular embodiment, the second thermoplastic composition 14 and the third thermoplastic composition 16 have different meting temperatures.

For example, as shown in FIG. 1, the second thermoplastic composition 14 forms flakes 20.

Some of the flakes 20 forms part of the upper surface 11, the rest of the upper surface being at least partly formed by the third thermoplastic composition 16.

As a variant (not shown), the second thermoplastic composition 14 forms flakes and the third thermoplastic composition 16 forms flakes.

The shapes 18 are formed by the color contrast between the second and third thermoplastic compositions 14, 16.

As a variant (not shown), the wear layer 5D includes only one thermoplastic composition.

As another variant (not shown), the wear layer 5D includes more than two thermoplastic compositions having distinct colors.

The wear layer 5D is advantageously obtained by random fusion of the granules of at least the second thermoplastic composition 14, which creates decorative patterns, even without a pigment being present.

The first thermoplastic composition 12 includes one or several thermoplastic polymer(s), P1 phr of one or several filler(s), and P2 phr of one or several plasticizer(s).

Here, “phr” is a unit meaning “per hundred resin” and expresses a mass content relative to the thermoplastic polymer(s). This means that, per one hundred grams of said one or several thermoplastic polymer(s), the first thermoplastic composition 12 includes P1 grams of said one or several filler(s) and P2 grams of said one or several plasticizer(s).

phr values are obtained as a ratio of mass values.

For example, the first thermoplastic composition 12 comprises between 25 and 45 wt. % of said one or several thermoplastic polymer(s), more preferably between 30 and 40 wt. %.

The second thermoplastic composition 14 includes one or several thermoplastic polymer(s), P1′ phr of one or several filler(s), and P2′ phr of one or several plasticizer(s).

P1 and P2 are respectively greater than P1′ and P2′.

The third thermoplastic composition 16 includes one or several thermoplastic polymer(s), P1″ phr of one or several filler(s), and P2″ phr of one or several plasticizer(s).

P1 and P2 are respectively greater than P1″ and P2″.

For example, the second thermoplastic composition 14 and the third thermoplastic compositions 16 comprise between 30 and 60 wt. % of said one or several thermoplastic polymer(s), more preferably between 35 and 55 wt. %.

For example, P1 ranges from 100 to 200 phr, and P2 ranges from 35 to 60 phr.

For example, P1′ and P1″ range from 40 to 100 phr, and P2′ and P2″ range from 10 to 45 phr.

Advantageously, said one or several thermoplastic polymer(s) are PVC (polyvinyl chloride).

The first thermoplastic compositions 12, the second thermoplastic compositions 14 and third thermoplastic compositions 16 are advantageously devoid of any phthalate plasticizer.

The one or several phthalate free plasticizer(s) used is/are for example taken from the list consisting of DINCH, DEHCH, DOTP (DEHT), DOA (DEHA), INB, DBT, DPT, dibenzoates DPGDB/DEGDB and their mixtures, ATBC, DOS, DBS, TXIB, FAME (fatty acid methyl ester), TEG-EH/3G8 (TEG-EH (Triethylene Glycol Bis (2-EthylHexanoate))), and ESBO.

The phthalate-free plasticizers are selected from the group consisting of the lower alkyl esters of fatty acids, the lower alkyl esters of aromatic diacids, benzoates, citrates, phosphates, sulfonates, the alkyl esters of cyclohexane dicarboxylic acids, the dialkyl esters of aliphatic dicarboxylic acids and the alkyl esters of aromatic di-, tri-, or tetra-carboxylic acids, with the exception of orthophthalic acid.

According to an embodiment, the coating layer 10 is a radiation-curable coating and preferably contains at least one radiation-curable binder and at least one photoinitiator.

The radiation-curable coating agent for example comprises an oligomer and/or polymer selected from the group consisting of (meth)acrylic copolymers, polyether (meth)acrylates, polyester (meth)acrylates, epoxy (meth)acrylates, urethane (meth)acrylates, amino(meth)acrylates, melamine (meth)acrylates, silicone (meth)acrylates and phosphazene (meth)acrylates or a mixture thereof.

According to another particular embodiment, the radiation-curable coating layer 10 contains at least one further ingredient, selected from the group consisting of: reactive thinners to reduce the viscosity, additives, light stabilisers, stabilisers, pigments, fillers, solvents, matting agents, and mixtures thereof.

### COMPOSITION EXAMPLES

An example of composition of the first thermoplastic composition 12 (core layer 5A) is provided in the following table:

| Components | Name | | phr |
|---|---|---|---|
| Polymer | PVC | VYNOVA S 5702 | 100 |
| Plasticizers | DINCH | ELATUR CH | 38 |
| | Epoxized soja bean oil | NOVASOL E50 | 5 |
| Filler | CaCO3 | CALCILIT 10 KA | 150 |
| Others | Processing aid | LG PA 912 | 1.2 |
| | Stabilizer | Bareostab 27 CP | 1.4 |
| | Pigment | Carbon paste | 0.6 |

So in the first thermoplastic composition 12, P1=150 phr and P2=43 phr.

Below is an example of composition of the second thermoplastic composition 14 (wear layer 5D):

| Components | Name | | phr |
|---|---|---|---|
| Polymer | PVC | Fantom | 100 |
| | | VYNOVA S 5702 | |
| Plasticizers | DINCH | ELATUR CH | 21 |
| | Epoxized soja bean oil | NOVASOL E50 | 7 |
| Filler | Ceramic microspheres | Omega spheres W300 | 76 |
| Others | Stabilizer | Bareostab 27 CP | 1.3 |
| | Additive | EVA Terpolymer. | 17 |
| | Pigment | Carbon paste | <1 |
| | | Irgazin Yellow K2070 | |

In the second thermoplastic composition 14, P1′=76 phr and P2′=28 phr.

In the example, the third thermoplastic composition 16 is similar to the second thermoplastic composition 14, except that it does not contain the yellow pigment Irgazin Yellow K2070 from BASF, but another one, for example a blue pigment such as EMBAPLAST BLUE P 109.

In the third thermoplastic composition 16, P1″=76 phr and P2″=28 phr.

### Micro-Scratch Resistance

In the example in FIG. 1, the decorative surface covering 1 has an upper surface 22 in the thickness direction N, on the side defined by the wear layer 5D with respect to the core layer 5A, formed by the coating layer 10, said upper surface 22 having a micro-scratch resistance at least MSR-B2 and preferably MSR-B1 according to the norm EN 16094 of March 2012.

This norm provides two standardized ways of testing micro-scratch resistance. Procedure B allows categorizing material in five categories:
MSR-B1: No visible scratches after testing,
MSR-B2: Only few scratches,
MSR-B3: Many well visible scratches,
MSR-B4: A great many well visible raw and fine scratches, Lissajous figure partly visible, and
MSR-B5: Mix of Lissajous figure and great many scratches, mat abrasion like area in the middle.

However, when there is no coating layer, the upper surface 22 is formed by the upper surface 11 of the assembly 5, and said upper surface 11 having a micro-scratch resistance at least MSR-B2 and preferably MSR-B1 according to the norm EN 16094 of March 2012. Moreover, it can be noticed that only the wear layer 5D and the coating layer 10 have a good microscratch resistance, whereas the core layer 5A does not. The core layer 5A has a bottom surface having a micro-scratch resistance MSR-B5 according to the norm EN 16094 of March 2012.

### Installation for Manufacturing the Decorative Surface Coverings

With reference to FIGS. 2 and 3, an installation 30 for producing the decorative surface covering 1 (and many others) will be described.

The installation 30 comprises a pressing system 35 (also show in FIG. 3) providing the assembly 5, and a coating line 40 for obtaining slabs 45 or rolls 3, and a finishing line 50 for obtaining the decorative surface coverings such as the decorative surface covering 1.

The pressing system 35 is for example a double belt press. The pressing system 35 comprises a conveying member 52 which is advantageously a first belt of the double-belt press and has an upper face 54 adapted for carrying the components of assembly 5. The pressing system 35 comprises a second belt 56 having a lower face 58 facing the upper face 54. The pressing system 35 also comprises a unit 60 for scattering granules 62 of the first thermoplastic composition 12 and obtaining a first layer of granules 64 on the conveying member 52, a unit 66 for superimposing the reinforcement layers 5B, 5C on the first layer of granules, and a unit 68 for scattering granules 69 and other granules 70 of respectively the second and third thermoplastic compositions 14, 16 and obtaining a second layer of granules 72 on the conveying member 52.

The pressing system 35 is adapted for pressing perpendicularly to the first layer of granules 64 and the second layer of granules 72.

The pressing system 35 is for example known as Thermofix®.

By “double belt press”, it is for example meant a press having at least two belts able to convey and press the components of the assembly 5. In variants (not shown), one of, or both the conveying member 52 and the second belt 56 may be replaced by several belts having the same function as the replaced belts. In other words, a “double belt press” is advantageously not limited to a press strictly having only two belts.

As a variant (not shown), the conveying member 52 is a belt which is distinct from the pressing belts of the double-belt press.

As shown in FIG. 3, the unit 66 comprises two systems 74, 76, known in themselves, for respectively unwinding the reinforcement layers 5B, 5C and guiding them towards the first layer of granules 64.

As variants (not shown), the unit 66 comprises only the system 74, or more than the two systems 74, 76 for unwinding reinforcement layers as explained above.

The system 76 is adapted for applying the reinforcement layer 5C directly on the reinforcement layer 5B.

As a variant (not shown), the system 76 is adapted for applying the second reinforcement layer 5C in between two sub-layers 64A and 64B of the first layer of granules 64, as shown in the right side of FIG. 4. In this case, the unit 60 is adapted for scattering the granules 62 below and above the second reinforcement layer 5C.

The upper face 54 and the lower face 58 are configured to run at the same speed in order to convey and compress the first layer of granules 64, the reinforcement layers 5B, 5C and the second layer of granules 72.

The pressing system 35 also includes systems (not represented and well known in themselves) adapted to heat and cool off the first layer of granules 64 and the second layer of granules 72, as well as to adjust the thickness of the assembly 5.

The coating line 40 (FIG. 2) is also known in itself. The coating line 40 comprises a unit 78 for depositing a layer of radiation-curable coating agent 80 on the upper surface 11 of the assembly 5, and a unit 82 for curing the radiation-curable coating agent and obtaining the coating layer 10. The coating line 40 also comprises a conveying system 96 for carrying the assembly 5 with the added coating layer 10.

The finishing line 50 is adapted for cutting the slabs 45 into parts 95 having a predetermined shape, and optionally:
beveling the parts, and/or
providing at least two opposite edges of the parts with a connecting system, for example by milling operations, and/or
applying an adhesive (not represented) on the parts, in order to obtain the decorative surface coverings 1.

In another embodiment, the finishing line is adapted to produce the roll 3 by cutting and rolling the coated assembly 5.

### Process for Manufacturing the Decorative Surface Coverings

The operation of the installation 30 stems from its structure and will now be described.

The pressing system 35 advantageously works in a continuous manner. The unit 60 scatters the granules 62 in order to obtain the first layer of granules 64 on the upper face 54 of the conveying member 52.

The conveying member 52 carries the first layer of granules 64 under the system 74 which unwinds the reinforcement layer 5B and applies it on the first layer of granules.

The conveying member 52 carries the first layer of granules 64 and the reinforcement layer 5B under the system 76 which unwinds the second reinforcement layer 5C and applies it directly on the reinforcement layer 5B.

The conveying member 52 carries the first layer of granules 64 and the reinforcement layers 5B, 5C under the unit 68 which scatters the granules 69, 70 on the reinforcement layer 5C in order to obtain the second layer of granules 72.

The granules 69, 70 are scattered in such a way that the second and third thermoplastic compositions 14, 16 form the shapes 18 on the upper surface 11 of the second layer of granules 72.

Then the set of superimposed layers is pressed between the conveying member 52 and the second belt 56. The set is also heated in order to at least partially melt the first layer of granules 64 and the second layer of granules 72. As a result, the reinforcement layers 5B, 5C, while remaining in contact with each other, are impregnated at least partly by the molten layers of granules. This also forms the core layer 5A and the wear layer 5D of the assembly 5 as shown in FIG. 1. After cooling, the assembly 5 behaves as a solid.

The pressing system 35 also sets the required thickness of the assembly 5 which is obtained at an outlet of the press.

Then the assembly 5 is used to produce the decorative surface covering 1. This step does not include adhering any printed film on or above the assembly 5, and in particular does not include any laminating substep.

The assembly 5 enters the coating line 40 (FIG. 2).

The unit 78 provides the layer of radiation-curable coating agent 80 applied on the assembly 5. The unit 82 cures the layer of radiation-curable coating agent 80 and forms the coating layer 10.

The slabs 45 are obtained by cutting the product continuously exiting the coating line 40. The slabs 45 have the structure of the decorative surface covering 1.

The slabs 45 then enter the finishing line 50, where they are cut to the required dimensions and beveled in order to obtain the decorative surface coverings. Advantageously at least two opposite edges of the tile are milled to create connecting systems (not represented). Optionally an adhesive (not represented) is applied on the back side of the tile, for installation of the tile.

As an alternative, the finishing line 50 produces the rolls 3, which may be cut or not. Thanks to the above mentioned features, no further laminating step is needed to obtain decorative surface coverings having decorative properties, and resistant to delamination. The process provides decorative surface coverings that are both resistant and aesthetical, at a lower cost.

1. A decorative surface covering defining a thickness direction and comprising an assembly having along the thickness direction:
a core layer comprising a first thermoplastic composition, the first thermoplastic composition including one or several thermoplastic polymer(s), P1 phr of one or several filler(s), and P2 phr of one or several plasticizer(s),
at least one reinforcement layer, and
a wear layer comprising at least a second thermoplastic composition, the second thermoplastic composition including one or several thermoplastic polymer(s), P1′ phr of one or several filler(s), and P2′ phr of one or several plasticizer(s),
wherein P1 and P2 are respectively greater than P1′ and P2′.

2. The decorative surface covering according to claim 1, wherein said at least one reinforcement layer contains at least 50 wt % of glass fibers

3. The decorative surface covering according to claim 1, devoid of any printed film located on or above the assembly.

4. The decorative surface covering according to claim 1, further comprising a coating layer located on the wear layer, the coating layer including a radiation-curable coating agent.

5. The decorative surface covering according to claim 4, wherein the radiation-curable coating agent comprises an oligomer and/or polymer selected from the group consisting of (meth)acrylic copolymers, polyether (meth)acrylates, polyester (meth)acrylates, epoxy (meth)acrylates, urethane (meth)acrylates, amino(meth)acrylates, melamine (meth)acrylates, silicone (meth)acrylates and phosphazene (meth)acrylates or a mixture thereof.

6. The decorative surface covering according to claim 1, comprising a second reinforcement layer adjacent to the first reinforcement layer, or sandwiched between two sub-layers of the core layer.

7. The decorative surface covering according to claim 1, wherein said one or several thermoplastic polymer(s) of the first composition and of the second composition are polyvinylchloride.

8. The decorative surface covering according to claim 1, wherein said one or several plasticizer(s) in the first thermoplastic composition and in the second thermoplastic compositions are phthalate-free.

9. The decorative surface covering according to claim 8, wherein said one or several plasticizer(s) in the first thermoplastic composition and in the second thermoplastic compositions are selected from the group consisting of the lower alkyl esters of fatty acids, the lower alkyl esters of aromatic diacids, benzoates, citrates, phosphates, sulfonates, the alkyl esters of cyclohexane dicarboxylic acids, the dialkyl esters of aliphatic dicarboxylic acids and the alkyl esters of aromatic di-, tri-, or tetra-carboxylic acids, with the exception of orthophthalic acid.

10. The decorative surface covering according to claim 1, wherein the wear layer further comprises a third thermoplastic composition, the second thermoplastic composition and the third thermoplastic composition having distinct colors and forming shapes on an upper surface of the assembly.

11. The decorative surface covering according to claim 1, wherein the second thermoplastic composition comprises between 30 and 60 wt. % of said one or several thermoplastic polymer(s).

12. The decorative surface covering according to claim 11, wherein the second thermoplastic composition comprises between 35 and 55 wt. % of said one or several thermoplastic polymer(s).

13. The decorative surface covering according to claim 1, wherein P1′ ranges from 40 to 100 phr, and P2′ ranges from 10 to 45 phr.

14. A process for manufacturing a decorative surface covering according to claim 1, the process comprising the following steps:
scattering granules of the first thermoplastic composition on a conveying member in order to obtain a first layer of granules,
applying said at least one reinforcement layer on the first layer of granules,
scattering granules of at least the second thermoplastic composition above said at least one reinforcement layer in order to obtain a second layer of granules,
pressing and heating the first layer of granules, said at least one reinforcement layer and the second layer of granules until melting or at least softening the first layer of granules and the second layer of granules in order to obtain the assembly after cooling, and
using the assembly in order to produce the decorative surface covering.

15. The process according to claim 14, wherein the step of pressing includes pressing the first layer of granules, the at least one reinforcement layer and the second layer of granules in a double-belt press.
